(19) United States
(12) Patent Application Publication
(10) Pub. No.: US 2019/0383374 A1
(43) Pub. Date: Dec. 19, 2019

(54) ELECTROMECHANICAL ACTUATION SYSTEM

(71) Applicant: ZF FRIEDRICHSHAFEN AG, Friedrichshafen (DE)

(72) Inventor: Daniel PFEIFFER, Berg (DE)

(73) Assignee: ZF FRIEDRICHSHAFEN AG, Friedrichshafen (DE)

(21) Appl. No.: 16/464,072

(22) PCT Filed: Oct. 23, 2017
(86) PCT No.: PCT/EP2017/076955

§ 371 Date: May 24, 2019

(30) Foreign Application Priority Data
Nov. 28, 2016 (DE) 10 2016 223 554.0

(51) Int. Cl. F16H 37/12; H02K 7/116; F16H 1/28

(52) U.S. Cl. CPC F16H 37/124; F16H 1/28; H02K 7/1166

(57) ABSTRACT

An electromechanical actuation system for obtaining at least two switching positions is proposed, that has an electric drive (1) for the normal operating mode, and an energy storage unit (2) for the emergency operating mode, which are coupled to an epicyclic gearing (3). The epicyclic gearing (3) is coupled to a movement transferring device (4) that converts a rotational movement into a linear movement in order to obtain the switching positions in the normal operating mode and in the emergency operating mode.

The present invention relates to an electromechanical actuation system for obtaining or approaching at least two switching positions according to the type defined in greater detail in the preamble of claim 1.

A parking lock assembly that has a first power path for releasing and locking a parking lock gear in a normal operating mode and a second power path for locking the parking lock gear in an emergency operating mode is known from the not yet published application by the applicant with the official filing number DE 10 2015 206 156 A1. The first power path and the second power path are mechanically coupled to one another via an epicyclic gearing. In the emergency operating mode a torque can be applied to the parking lock gear with the parking lock assembly when the first power path is blocked, such that the parking lock gear is engaged. As a result, it is only possible to engage the parking lock. By way of example, in an emergency operating mode it is nevertheless necessary that the parking lock assembly can also be disengaged if required. This is not possible, however, with the parking lock assembly described above.

The fundamental object of the present invention is to propose an electromechanical actuation system of the type described above, in which at least two switching positions can be obtained in both the normal operating mode and in an emergency operating mode with the structurally simplest means.

This problem is solved according to the invention by the features of claim 1. Further advantageous embodiments can be derived from the dependent claims and the description, as well as the drawings.

An electromechanical actuation system is thus proposed, in particular for a vehicle, for obtaining at least two switching positions. The actuation system comprises at least one electric drive for the normal operating mode, and at least one energy storage unit functioning as a drive for the emergency operating mode, wherein both the electric drive and the energy storage unit can be or are coupled to an epicyclic gearing. In order to define a particularly simple possibility in which the switching positions can be obtained in both a normal operating mode as well as an emergency operating mode, the epicyclic gearing can be or is coupled to a motion transferring device, or the like, that converts a rotational or rotary movement into a linear or translatory movement, in order to obtain the switching positions in a normal operating mode as well as in an emergency operating mode.

Accordingly, the electromechanical actuation system can be functionally expanded without further necessary structural effort in that numerous positions, but at least two, can be approached by a linear movement with a defined force in not only the normal functioning, or normal operating mode, but also in an emergency functioning or emergency operating mode.

An eccentric can be used as the motion transferring device for converting a rotational movement generated by the electric drive, or the energy storage unit, into a linear movement, which is functionally connected to a component that executes the linear movement. Various structural designs are conceivable for this. A structural design that makes particularly good use of installation space may include an eccentric disk with an eccentric pin, which is functionally connected to a component that executes the linear movement, e.g. a slider, etc. As a result of the rotational movement of the electric drive or the energy storage unit, it is then possible to successively obtain numerous switching positions without changing the direction of the rotational movement. Consequently, by using an eccentric as the motion transferring device, the rotational movement of the electric motor, or the gearing, can be converted to a linear, or axial movement of the slider. Because the pin, or tappet, is not in the center of the eccentric disk, installation space is saved with regard to the gearing ratio, such that it is basically possible to expand the functioning thereof, without requiring more installation space.

The electromechanical actuation system proposed according to the invention can be used anywhere where an actuation is necessary for obtaining switching positions, etc. A particularly advantageous field of application is that of parking lock assemblies in automatic transmissions for vehicles. The proposed actuation system is used for engaging or disengaging the parking lock assembly thereby. As a result, a parking lock gear in the parking lock assembly is locked or released by the actuation system in both the normal operating mode and in an emergency operating mode.

The present invention shall be explained in greater detail below with reference to the drawings. Therein:

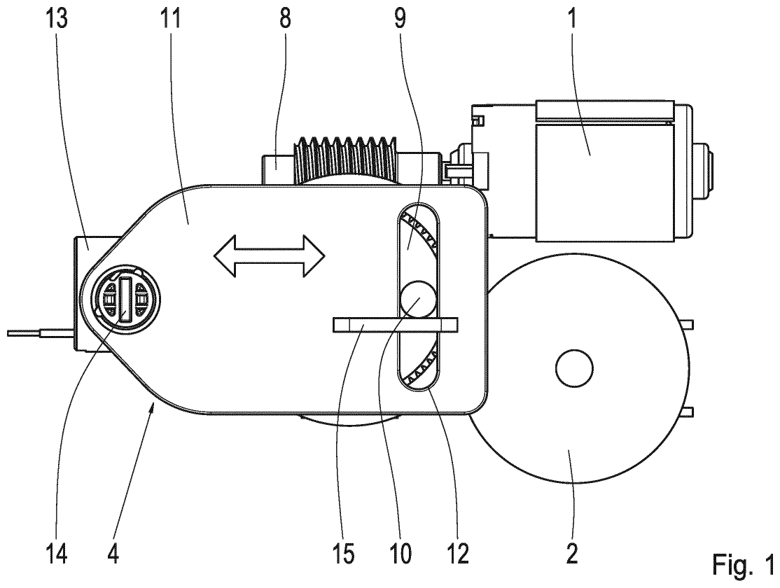

FIG. 1 shows a schematic side view of an exemplary embodiment variation of an electromechanical actuation system according to the invention for obtaining at least two switching positions;

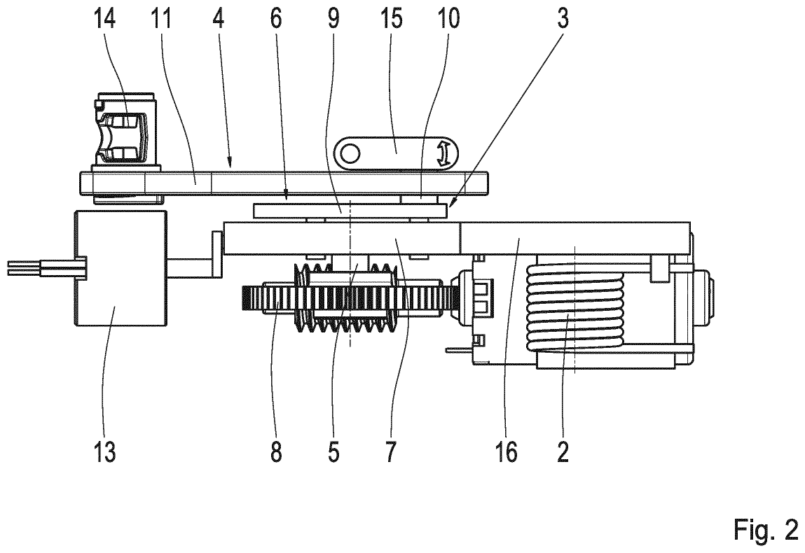

FIG. 2 shows a schematic top view of the electromechanical actuation system according to FIG. 1;

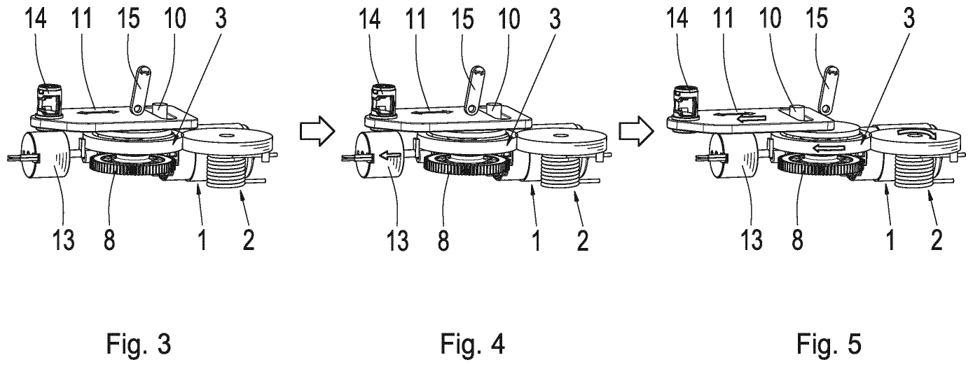

FIG. 3 shows a schematic illustration of the electromechanical actuation system in an emergency operating mode for an emergency disengagement in a first switching position, which forms the initial position;

FIG. 4 shows a schematic illustration of the actuation system when it is actuated in order to move the actuator to the second switching position;

FIG. 5 shows a schematic illustration of the actuation system in the second switching position, which forms the second end position;

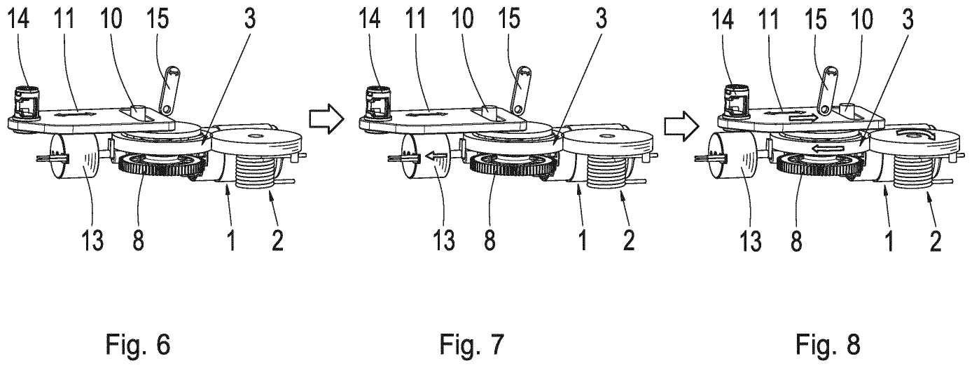

FIG. 6 shows a schematic illustration of the electromechanical actuation system in an emergency operating mode for an emergency engagement in a second switching position, which forms the initial position;

FIG. 7 shows a schematic illustration of the actuation system when it is actuated in order to move the actuator to the first switching position; and

FIG. 8 shows a schematic illustration of the actuation system in the first switching position, which forms the first end position.

A possible embodiment variation of an electromechanical actuation system according to the invention for obtaining or approaching at least two switching positions is illustrated by way of example in FIGS. 1 to 8.

The proposed electromechanical actuation system comprises an electric drive 1, e.g. in the form of an electric motor, etc., for the normal operating mode, and an energy storage unit 2, e.g. an electrical or mechanical energy storage unit, for the emergency operating mode. Both the electric drive 1 as well as the energy storage unit 2 are coupled to an epicyclic gearing, which forms a planetary gearing or planetary gear set 3.

The epicyclic gearing, or planetary gearing 3, is coupled to a motion transferring device 4 that converts a rotational movement into a linear movement or translatory movement in order to obtain the switching positions in a normal operating mode and in an emergency operating mode.

In detail, the electric drive 1 is coupled to a first element of the planetary gearing 3. A second element of the planetary gearing 3 is coupled to the motion transferring device 4, while a third element of the planetary gearing 3 is coupled to the energy storage unit 2. In the embodiment variation shown by way of example, a sun gear 5 forms the first element of the planetary gearing 3, a planet gear carrier 6 forms the second element of the planetary gearing 3, and a ring gear 7 forms the third element.

With the electromechanical actuation system according to the invention, the electric drive 1 is provided in the normal operating mode via the first element, or the sun gear 5, of the planetary gearing 3, and the drive for obtaining the at least two switching positions is provided via the second element, or via the planet gear carrier 6, of the planetary gearing 3, when the third element, or the ring gear 7, of the planetary gearing 3 is blocked. In contrast, in the emergency operating mode, the drive is provided via the third element, or the ring gear 7 of the planetary gearing 3, wherein the drive is provided by the energy storage unit 2, and the drive for obtaining the at least two switching positions is provided via the second element, or via the planet gear carrier when the first element, or the sun gear 5, of the planetary gearing 3 is blocked.

The sun gear is connected to the electric drive 1 via a worm gear 8, wherein the planet gear carrier 6 of the planetary gearing 3 is part of the motion transferring device 4 in the embodiment shown here, wherein the planetary gears on the planet gear carrier 6 mesh with the ring gear 7 of the planetary gearing 6, wherein the ring gear 7 is functionally connected to the energy storage unit 2.

In the exemplary embodiment variation shown herein, an eccentric disk 9 that has an eccentric pin 10 forms the motion transferring device 4, wherein the pin 10 is functionally connected to a slider 11 in the motion transferring device 4 that can move linearly. In this manner, the rotational movement generated by the planetary gearing is converted to a linear movement or translatory movement of the slider 11 in order to obtain the switching positions. For this, the pin 10 is inserted in a hole 12 that is perpendicular to the linear movement of the slider 11 in order to convert the rotational movement into the linear movement of the slider 11 in both the normal operating mode and the emergency operating mode.

In the embodiment variation shown here, the planet gear carrier 6 is thus basically an eccentric disk 9, such that these two components form a combined component. It is also conceivable, however, for these to be separate components.

The functioning of the actuation system according to the invention shall be explained on the basis of the use thereof in a parking lock assembly for an automatic vehicle transmission, in which the actuation system for locking and releasing a parking lock gear is used in the normal operating mode and in the emergency operating mode, wherein the motion transferring device 4 is functionally connected to the parking lock gear.

In the normal functioning or normal operating mode of the actuation system, the electric drive, or the electric motor 1 drives the sun gear 5 of the planetary gearing 3 via a worm gear 8. The worm gear 8 is used for implementing a self-locking function. In the further course of the normal functioning, the sun gear 5 drives the planet gear carrier 6 in the form of an eccentric disk 9 via the planet gears of the planetary gearing 3. As a result, the eccentric disk 9 rotates about the central axis of the planetary gearing 3, wherein the off-center, or eccentric, pin 10 moves in the hole 12 of the slider 11 in order to convert the rotational movement into an axial movement of the slider 11.

For the normal functioning, or normal operating mode, the ring gear 7 of the planetary gearing must be blocked, which takes place via an emergency actuator in the form of a locking element 13, which either block or releases the ring gear 7 of the planetary gearing 3. The axial movement is obtained through the hole, or longitudinal groove on the slider 11, in which the pin 10 on the eccentric disk 9 is guided. It is also possible to obtain further intermediate positions, in addition to the at least two intended switching positions, with the actuation system connected to the parking lock gear or other components that are to be activated.

An emergency function is obtained with the proposed actuation system, which also enables actuation of the parking lock or the parking lock gear when the normal operating mode is defective or deactivated. This means that the electric drive 1 can no longer be actuated. The actuation or deactivation of the emergency operating mode takes place via the locking element 13 in the form of a locking magnet, for example, or through a manual actuation. Depending on the position of the slider 11, when the ring gear 7 is released, the energy storage unit 2, e.g. a spring, etc. is released, by means of which the ring gear 7 is driven, and because the sun gear 5 is locked in place by the worm gear 8, the eccentric disk 9 is driven via the planet gears. The eccentric disk 9 is then rotated over a predefined angle of 180° in FIGS. 3 to 8, by means of which the system, or the actuation system, is moved to the first switching position or the second switching position. The two switching positions, or the two end positions, can be obtained successively with just one energy storage unit 2 because the direction of rotation remains the same. The uniform direction of rotation is obtained by the design comprising the eccentric disk 9 in the motion transferring device 4.

The two switching positions can be obtained successively in both the normal operating mode and the emergency operating mode with the actuation system according to the invention, wherein the normal operating mode and the emergency operating mode preferably have different directions of rotation.

The functioning of the emergency disengagement of the parking lock gear is shown in FIGS. 3 to 5, which is not further illustrated. FIG. 3 shows an actuation receiver 14 for actuating the parking lock gear, or for transferring a linear movement to the parking lock gear or another component that is to be actuated. The actuation system is in a first switching position, which is to the right in the drawing plane, thus forming the right-hand end position. The initial actuation of the parking lock is shown in FIG. 4, in which the sun gear 5 is blocked via the worm gear 8. The end of the emergency disengagement of the parking lock gear is shown in FIG. 5, wherein the eccentric disk 9 is rotated by the energy storage unit 2, and the slider 11 is moved toward the left in the drawing plane, into the second switching position, or into the left-hand end position. As a result, the parking lock gear is disengaged by the actuation receiver 14 attached to the slider 11.

The emergency operating mode is described or illustrated in FIGS. 6 to 8 on the basis of the functioning of the emergency engagement of the parking lock gear. FIG. 6 shows the slider 11 with the actuation receiver 14 in the left-hand end position, or in the second switching position. Because the sun gear 5 is still blocked, when the eccentric disk 9 is rotated further by the energy storage unit 2, the emergency engagement is initiated, as is shown in FIG. 7. FIG. 8 shows the end of the emergency engagement of the parking lock gear, wherein the slider 11 with the receiver 14 is moved to the first switching position, or into the right-hand end position.

After the emergency operating mode, or emergency functioning, has been activated, an electric energy storage unit 2 must be recharged, or a mechanical energy storage unit 2 must be re-tensioned, for example. This can take place, for example, in that the planet gear carrier 6, or the eccentric disk 9 is blocked, in order to rotate the ring gear 7 via the electric drive 1, and to reset or re-tension the energy storage unit 2 in the form of a spring. The ring gear 7 and the energy storage unit 2 are preferably connected to one another, or functionally connected to one another, via a gearing ratio 16. The locking element 13 must not block the ring gear 7 in doing so. The locking element 13 can be activated for this, for example, or the ring gear 7 can have a freewheeling function. A blocking of the eccentric disk 9 can be obtained via a switch, or via a direct connection to the locking element 13.

There is a blocking lever 15 on the slider 11 in the region of the hole 12, with which the movement of the pin 10 on the eccentric disk 9 can be delimited in the oblong hole 12. The blocking lever 15 tensions the energy storage unit 2, and also prevents a returning to the first switching position and the second switching position when the first switching position and the second switching position have been obtained.

### REFERENCE SYMBOLS

1 electric drive
2 energy storage unit
3 epicyclic gearing or planetary gearing
4 motion transferring device
5 sun gear
6 planet gear carrier
7 ring gear
8 worm gear
9 eccentric disk
10 tappet or pin
11 slider
12 hole or longitudinal groove
13 locking element or locking magnet
14 actuation receiver
15 blocking lever

1. An electromechanical actuation system for obtaining at least two switching positions, which has an electric drive for the normal operating mode and an energy storage unit for the emergency operating mode, which are coupled to an epicyclic gearing, characterized in that the epicyclic gearing is coupled to a motion transferring device that converts a rotational movement into a linear movement, in order to obtain the switching positions in the normal operating mode and in the emergency operating mode.

2. The electromechanical actuation system according to claim 1, characterized in that a planetary gearing forms the epicyclic gearing, wherein the electric drive is coupled to a first element of the planetary gearing, wherein a second element of the planetary gearing is coupled to the motion transferring device, and wherein a third element of the planetary gearing is coupled to the energy storage unit.

3. The electromechanical actuation system according to claim 2, characterized in that in the normal operating mode, the drive is provided via the first element of the planetary gearing, and the drive for obtaining the at least two switching positions is provided via the second element of the planetary gearing when the third element of the planetary gearing is blocked, and that in the emergency operating mode, the drive is provided via the third element of the planetary gearing, and the drive for obtaining the at least two switching positions is provided via the second element when the first element of the planetary gearing is blocked.

4. The electromechanical actuation system according to claim 2, characterized in that the first element of the planetary gearing is a sun gear connected to the electric drive via a worm gear, the second element of the planetary gearing is a planet gear carrier, which is in the form of a separate component or is part of the motion transferring device, and in that the planet gears on the planet gear carrier mesh with the ring gear that forms the third element of the planetary gearing, which is functionally connected to the energy storage unit.

5. The electromechanical actuation system according to claim 4, characterized in that the motion transferring device comprises an eccentric disk with an eccentric pin thereon, wherein the pin is functionally connected to a slider of the motion transferring device that can be moved linearly.

6. The electromechanical actuation system according to claim 5, characterized in that the pin is guided in a hole at a right angle to the linear movement of the slider, in order to convert the rotational movement of the eccentric disk to a linear movement of the slider in order to obtain the at least two switching positions in both the normal operating mode as well as the emergency operating mode.

7. The electromechanical actuation system according to claim 2, characterized in that, with a mechanical energy storage unit, the third element of the planetary gearing is functionally connected to the energy storage unit in the form of a spring via a gear ratio for mechanically tensioning the spring.

8. The electromechanical actuation system according to claim 2, characterized in that a locking element is provided as an emergency actuator for locking and deactivating the emergency operating mode, which blocks or releases the third element of the planetary gearing.

9. The electromechanical actuation system according to claim 6, characterized in that the movement of the pin in the hole in the slider can be delimited by a blocking lever.

10. The electromechanical actuation system according to claim 1, characterized in that the actuation system can be used with a parking lock gear in an automatic vehicle transmission for locking and releasing it in the normal operating mode and in the emergency operating mode, wherein the motion transferring device is functionally connected to the parking lock gear.

11. The electromechanical actuation system according to claim 3, characterized in that the first element of the planetary gearing is a sun gear connected to the electric drive via a worm gear, the second element of the planetary gearing is a planet gear carrier, which is in the form of a separate component or is part of the motion transferring device, and in that the planet gears on the planet gear carrier mesh with the ring gear that forms the third element of the planetary gearing, which is functionally connected to the energy storage unit.

12. The electromechanical actuation system according to claim 3, characterized in that, with a mechanical energy storage unit, the third element of the planetary gearing is functionally connected to the energy storage unit in the form of a spring via a gear ratio for mechanically tensioning the spring.

13. The electromechanical actuation system according to claim 4, characterized in that, with a mechanical energy storage unit, the third element of the planetary gearing is functionally connected to the energy storage unit in the form of a spring via a gear ratio for mechanically tensioning the spring.

14. The electromechanical actuation system according to claim 5, characterized in that, with a mechanical energy storage unit, the third element of the planetary gearing is functionally connected to the energy storage unit in the form of a spring via a gear ratio for mechanically tensioning the spring.

15. The electromechanical actuation system according to claim 3, characterized in that a locking element is provided as an emergency actuator for locking and deactivating the emergency operating mode, which blocks or releases the third element of the planetary gearing.

16. The electromechanical actuation system according to claim 4, characterized in that a locking element is provided as an emergency actuator for locking and deactivating the emergency operating mode, which blocks or releases the third element of the planetary gearing.

17. The electromechanical actuation system according to claim 7, characterized in that the movement of the pin in the hole in the slider can be delimited by a blocking lever.

18. The electromechanical actuation system according to claim 8, characterized in that the movement of the pin in the hole in the slider can be delimited by a blocking lever.

19. The electromechanical actuation system according to claim 2, characterized in that the actuation system can be used with a parking lock gear in an automatic vehicle transmission for locking and releasing it in the normal operating mode and in the emergency operating mode, wherein the motion transferring device is functionally connected to the parking lock gear.

20. The electromechanical actuation system according to claim 3, characterized in that the actuation system can be used with a parking lock gear in an automatic vehicle transmission for locking and releasing it in the normal operating mode and in the emergency operating mode, wherein the motion transferring device is functionally connected to the parking lock gear.
